(19) United States
(12) Patent Application Publication
(10) Pub. No.: US 2002/0007254 A1
(43) Pub. Date: Jan. 17, 2002

(54) Automated evaluation system and program

(76) Inventors: Kazuyoshi Takeda, Nagano-Ken (JP); Yukinobu Momozono, Kagoshima-shi (JP)

Correspondence Address: EPSON RESEARCH AND DEVELOPMENT INC, INTELLECTUAL PROPERTY DEPT, 150 RIVER OAKS PARKWAY, SUITE 225, SAN JOSE, CA, 95134, US

(21) Appl. No.: 09/838,490

(22) Filed: Apr. 19, 2001

(30) Foreign Application Priority Data
Apr. 20, 2000 (JP) 2000-119722

(51) Int. Cl. G06F 11/30

(52) U.S. Cl. 702/182

(57) ABSTRACT

It is an object of the present invention to provide an automated evaluation system that can retain the quality of an application program and also maintain the stability in the automated evaluation.

An automated evaluation system 1 that automatically evaluates an application program to be operated on a target system according to a given input event and a reference output result corresponding to the given input event, the automated evaluation system 1 is characterized in being accessible to a simulation apparatus 2 that simulates an operation of the application program, and comparing a simulation result corresponding to the given input event by the simulation apparatus with the reference output result to thereby perform an automated evaluation.

### TECHNICAL FIELD

The present invention relates to an automated evaluation system that automatically evaluates an application program that operates on a target system such as a micro computer (herein after referred to as a microcomputer) according to input events such as key inputs and reference outputs such as output pictures and the like with respect to the input events.

### BACKGROUND TECHNOLOGY

In recent years, microcomputers are widely used and implemented in a variety of apparatuses such as home electric appliances. A microcomputer has a built-in ROM (Read Only Memory) in which an application program is written, in order to operate according to the specification of an apparatus in which the microcomputer is implemented or peripheral apparatuses therefor. Also, liquid crystal display apparatuses (hereinafter referred to as LCDs “Liquid Crystal Displays”) are implemented in a variety of apparatuses such as home electric appliances. Therefore, when the user inputs an input event such as a key input, a microcomputer outputs to a LCD an output picture corresponding to the input event according to an application program. In this respect, in the event of confirming the operation of the application program by the microcomputer, output results for numerous input events according to the specification of an apparatus in which the microcomputer is implemented must be confirmed.

Accordingly, when a microcomputer is developed, not only development of its hardware is important, but also development of an application program is important. For development of an application program, an InCircuit Emulator (hereinafter referred to as ICE “InCircuit Emulator”) or the like is used. The ICE can emulate an operation of an application program on a target board. As described above, for confirming the operation of an application program, there are numerous input events that are to be confirmed. Therefore, when the operator directly inputs input events using the ICE, it takes a long time to input them, and there is a possibility that operator may make input errors. Also, when the operator confirms input events and emulated results by picture outputs, such a work takes a long time and there is a possibility that the operator may make confirmation errors.

Furthermore, in order to evaluate the application program by confirming its operation, the same events are repeatedly evaluated in order to improve the evaluation accuracy. Therefore, in order to confirm the operation of the application program more efficiently at a higher accuracy, an automated evaluation system that can automatically and repeatedly input numerous input events and that automatically evaluates output results corresponding to the input events is used.

FIG. 4 shows a structure for performing an automated evaluation of an application program of a conventional microcomputer. An automated evaluation system 50 is composed on a personal purpose computer (hereinafter referred to as a personal computer) PC, and is capable of accessing a disk apparatus DU of the personal computer PC. Furthermore, the automated evaluation system 50 is equipped with an emulation expansion board 50a in order to enter input events in a target board TB. On the other hand, an ICE 51 is connected to the personal computer PC through an RS 232 and also to the target board TB. Also, a debugger 52 is implemented on the personal computer PC, such that, while the ICE 51 is emulating an application program AP, the debugger 52 can perform debugging. In the event of automatic evaluation of the application program AP, first, the operator prepares an input event file IF that stores a plurality of input events and a reference output file OF that stores reference output results corresponding to the input events. Then, when the automated evaluation system 50 is started, the automated evaluation system 50 reads an input event stored in the input event file IF and a reference output result stored in the reference output OF from the disk drive DU. Then, the automated evaluation system 50 enters the input event through the emulation expansion board 50a to the target board TB.

Then, the ICE 51 emulates the operation of the application program AP according to the input event, and outputs an output result to the automated evaluation system 50. Then, the automated evaluation system 50 compares the output result and the reference output result to determine whether or not the output result is correct, and outputs a determination result to a result log file or the like. Furthermore, the automated evaluation system 50 automatically performs the input, comparison and determination steps repeatedly for a plurality of input events and automatically evaluate the application program AP.

However, in the automated evaluation by the automated evaluation system 50 and ICE 51, data is transferred between the automated evaluation system 50 and the target board TB, and therefore a function for automated evaluation needs to be implemented. In other words, the automated evaluation system 50 needs the emulation expansion board 50a in order to convert input events to data for emulation. Furthermore, the target board TB is provided with an expansion board interface TBa implemented therein in order to receive input events and a personal computer interface TBb for outputting output results to the personal computer PC. Also, an automated evaluation system interface program IP is implemented in the application program AP in order to transfer data to a VRAM (Visual Random Access Memory) for analyzing the input events from the automated evaluation system 50 or outputting output results to the personal computer PC. As a result, the application program AP to be evaluated by the automated evaluation is different from an application program that is actually implemented in the microcomputer, and the automated evaluation system interface program IP adds a load to a process that is to be performed by the microcomputer. In this manner, when a function for automated evaluation is added, unstable factors in the evaluation increase and the quality of the application program AP to be evaluated lowers.

Therefore, it is an object of the present invention to provide an automated evaluation system that can retain the quality of an application program and also maintain the stability in the automated evaluation.

### DESCRIPTION OF THE INVENTION

An automated evaluation system in accordance with the present invention to solve the problems described above, wherein the automated evaluation system that automatically evaluates an application program to be operated on a target system according to a given input event and a reference output result corresponding to the given input event, is characterized in being accessible to a simulation apparatus that simulates an operation of the application program and comparing a simulation result corresponding to the given input event by the simulation apparatus with the reference output result to thereby perform an automated evaluation.

In accordance with the automated evaluation system that is accessible to the simulation apparatus, an automated evaluation can be performed using a simulation result corresponding to an input event for the simulation apparatus. In this instance, the simulation apparatus performs a normal simulation of an operation of the application program based on the input event. Accordingly, there is no need to implement a function for automated evaluation in the application program.

Furthermore, the automated evaluation system is equipped with a memory device that is accessible by the simulation apparatus and the automated evaluation system, and characterized in that the simulation apparatus compares the simulation result stored in the memory device with the reference output result.

According to the automated evaluation system that is equipped with a memory device that is accessible by the automated evaluation system and the simulation apparatus, the automated evaluation system and the simulation apparatus can be accessed to one another.

As a result, in an automated evaluation by the automated evaluation system and the simulation apparatus, a function for automated evaluation does not need to be implemented to perform the automated evaluation.

Furthermore, it is characterized in that the simulation apparatus and the automated evaluation system are realized using the same computer.

According to the automated evaluation system described above, the automated evaluation system and the simulator can communicate with each other regarding simulation results through a memory device provided in the computer.

Also, a program in accordance with the present invention, in which the program renders a computer to perform an automated evaluation of a application program to be operated on a target system according to a given input event and a reference output result corresponding to the given input event,

is accessible to a simulation apparatus that simulates an operation of the application program, and

compares a simulation result corresponding to the given input event by the simulation apparatus with the reference output result to thereby render the computer to perform an automated evaluation of the application program.

In accordance with the program, which is made accessible to the simulation apparatus, an automated evaluation can be performed using a simulation result for an input event of the simulation apparatus. In this instance, the simulation apparatus performs a normal simulation of an operation of the application program based on the input event. Accordingly, there is no need to implement a function for automated evaluation in the application program, and the automated evaluation system can be realized by the computer while retaining the quality of the application program.

Also, the program in accordance with the present invention is characterized in accessing to the simulation apparatus through an application programming interface implemented in an operating system of the computer.

According to the program described above, the automated evaluation system and the simulation apparatus can be accessed to one another using a function implemented in the operating system of the computer that performs the program.

### BRIEF DESCRIPTION OF THE DRAWINGS

FIG. 1 shows a structure of a personal computer in which an automated evaluation system in accordance with one embodiment of the present invention and a simulation apparatus are operated.

FIG. 2 is an illustration to describe accesses between an automated evaluation system in accordance with the embodiment of the present invention and a simulator.

FIG. 3 shows an example of input events and reference output results, wherein FIG. 3 (a) shows key inputs that are input events, FIG. 3 (b) shows a reference output picture on an LCD before the key inputs shown in FIG. 3 (a), and FIG. 3 (c) shows a reference result, which is a reference output picture on the LCD for the key inputs shown in FIG. 3 (a).

FIG. 4 shows a conventional structure to perform an automated evaluation of an application program of a microcomputer.

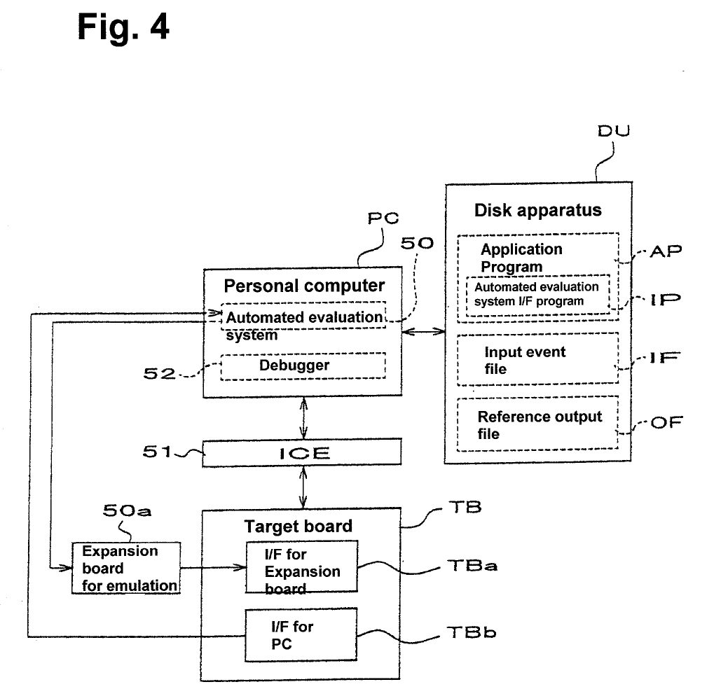

### BEST EMBODIMENTS TO IMPLEMENT THE INVENTION

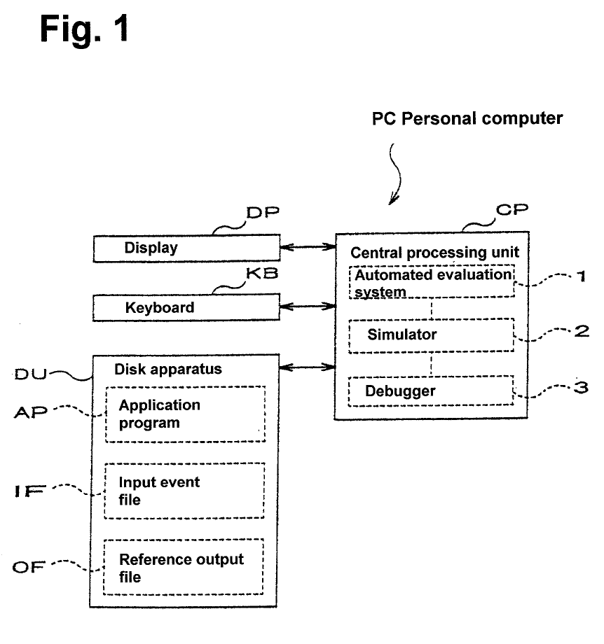

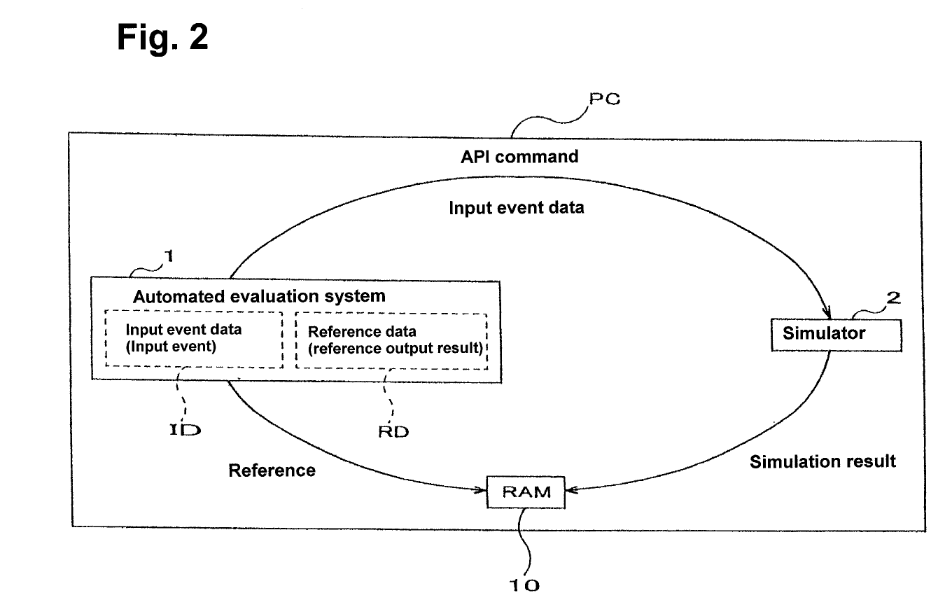

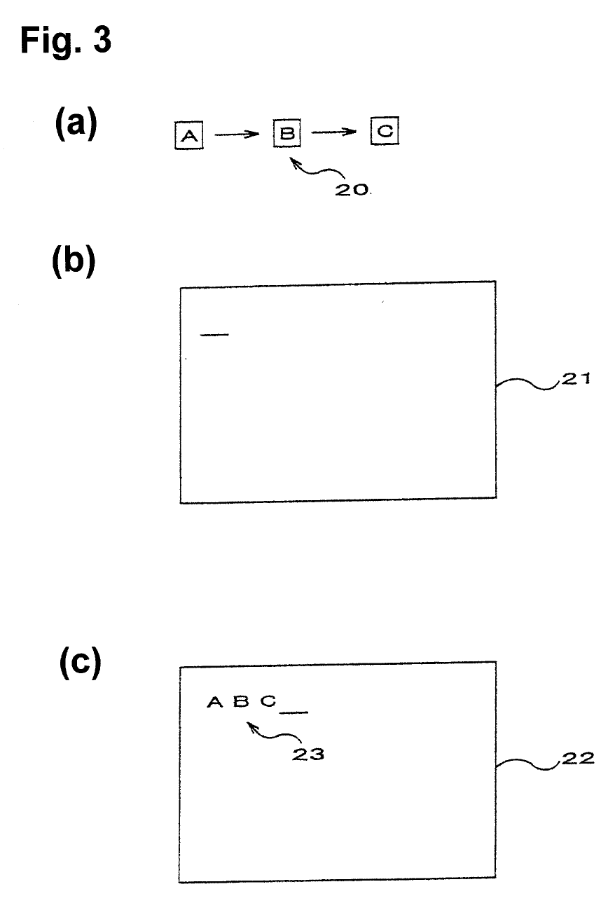

An automated evaluation system in accordance with an embodiment of the present invention is described below with reference to the accompanying drawings. FIG. 1 shows a structure of a personal computer in which an automated evaluation system and a simulation apparatus are operated. FIG. 2 is an illustration to describe accesses between the automated evaluation system and a simulator. FIG. 3 shows an example of input events and reference output results, wherein FIG. 3 (a) shows key inputs, FIG. 3 (b) shows a reference output picture on an LCD before the key inputs shown in FIG. 3 (a), and FIG. 3 (c) shows a reference output picture on the LCD for the key inputs shown in FIG. 3 (a).

The automated evaluation system in accordance with the present invention automatically evaluates an application program to be operated on a target system using a simulation result by the simulation apparatus. In this instance, the simulation apparatus performs a normal process, in which a simulation for an input event is performed and a result of the simulation is output. Therefore, a function for an automated evaluation does not need to be implemented in the application program.

It is noted that the target system is operated based on an application program. The target system includes, for example, a microcomputer. Also, input events to be applied are set according to the specification of an apparatus in which the target system is implemented, and input events to be applied vary depending on input devices of an apparatus in which the target system is implemented. Input events to be applied are, for example, key inputs, voice inputs, and the like. Reference output results are normal outputs of the target system according to input events, and are set for the specification of an apparatus in which the target system is implemented. Reference output results to be used vary depending on output devices of an apparatus in which the target system is implemented. Reference output results to be used include, for example, picture outputs, voice outputs, and the like.

In accordance with the embodiment of the present invention, the automated evaluation system is composed as an automated evaluation system that performs an automated evaluation through loading an automated evaluation program onto a personal computer through a storage media that stores the automated evaluation program and rendering the personal computer to execute an operation by the automatic automated evaluation program. Furthermore, the automated evaluation system uses a disk apparatus that is connected to the personal computer in order to take in input events and reference output results. Also, in accordance with the present embodiment, the simulation apparatus is composed as a simulator that performs a simulation through loading a simulation program onto the personal computer through a storage media that stores the simulation program and rendering the personal computer to execute an operation by the simulation program. It is noted that the automated evaluation system and the simulator may be composed within the same personal computer. Also, in accordance with the present embodiment, the target system is a microcomputer. Furthermore, in accordance with the present embodiment, the microcomputer can be implemented in an apparatus that can execute key (button) inputs from the exterior and picture outputs on an LCD, such as, for example, a gaming machine, a watch, a data bank and the like

First, referring to FIG. 1, the entire structure of an automated evaluation system 1 and a simulator 2 is described.

In the automated evaluation system 1, an automated evaluation program is read from a storage media that stores the automated evaluation program by a disk apparatus DU of a personal computer PC, the automated evaluation program is loaded onto a RAM (Random Access Memory) (not shown), and the automated evaluation program is executed by a central processing apparatus CP to perform an automated evaluation. The disk apparatus DU may be an apparatus that can read and write for a storage media such as a floppy disk, an optical disk and the like. Also, the automated evaluation system 1 reads an input event stored in an input event file IF from the disk apparatus DU, and transfers the input event to the simulator 2. Furthermore, the automated evaluation system 1 reads in a reference output result that is stored in a reference output file OF from the disk apparatus DU and compares the same with a simulation result for an input event of the simulator 2 to perform an automated evaluation. It is noted that the automated evaluation system 1 may store an evaluation result in the disk apparatus DU as a result log file, and outputs a picture on a display DP.

In the simulator 2, a simulation program is read from a storage media that stores the simulation program by the disk apparatus DU of the personal computer PC, the simulation program is loaded on the RAM (not shown), and the simulation program is executed by the central processing apparatus CP to perform a simulation. Also, the simulator 2 reads an application program AP of the microcomputer from the disk apparatus DU, and simulates an operation by the application program AP.

It is noted that, when an input event is transmitted by the automated evaluation system 1, the simulator 2 performs a simulation of the operation by the application program AP based on the input event. Then, the simulator 2 stores a result of the simulation in a RAM 10 of the personal computer PC (see FIG. 2).

Also, the simulator 2 can be externally operated by a keyboard KB corresponding to key inputs of the implemented apparatus, and outputs an LCD picture on the display DP corresponding to an LCD picture output of the implemented apparatus.

The simulator 2 is connected to a debugger 3, such that, while a simulation is performed, the application program AP can be debugged. With the debugger 3, a debug program is read from a storage media that stores the debug program by the desk apparatus DU of the personal computer PC, the program is loaded onto a RAM (not shown), and the program is executed by the central processing apparatus CB to perform a debugging. The debugger 3 can start and stop the simulator 2, refers to data or rewrite data on the simulator 2. Furthermore, the debugger 3 can execute the application program AP at each step or break it.

Next, the input event file IF and the reference output file OF are described below. The input event file IF and the reference output file OF can be created using an input event data creating function or a reference data creating function of the automated evaluation system 1, or may be created in advance by an editor.

First, the case in which the input event file IF is created by the automated evaluation system 1 is described. First, keys of the apparatus in which the microcomputer is implemented are assigned to keys in the keyboard KB by the automated evaluation system 1. Then, the user prepares multiple input events according to the specification of the implemented apparatus and inputs them one by one using the keys. Then, the automated evaluation system 1 confirms the key type for each of the input events and the input order as input event data. Finally, the automated evaluation system 1 stores the event data for the entire input events in the input event file IF. It is noted that the input event file IF is stored in a storage media with an optional filename being added and set in a state such that it can be read from the disk apparatus DU. Incidentally, the input event file IF can be modified according to changes in the specification of the microcomputer, changes in the specification of the implemented apparatus, changes in the evaluation contents and the like. For example, as shown in FIG. 3 (a), let us assume that a key operation is conducted for one input event 20, in which a key [A] is depressed, a key [B] is depressed and a key [C] is depressed in this order. In this case, the input event 20 is stored in the input event file IF as input event data defining key types of the keys A, B and C and the key input order.

Next, the case in which the reference output file OF is created by the automated evaluation system 1 is described. Since the reference output file OF stores reference data in which each one reference output result corresponds to each one input event, it is created corresponding to the creation of the input event file IF. Each time the user inputs an input event by operating a key, the automated evaluation system 1 transfers the key input to the simulator 2 as an input event. Then, the simulator 2 performs a simulation for the key input, and displays a simulation result on the display DP. Upon display, the user confirms the displayed content on the display DP, and confirms it as a reference output result if the content is correct. In this case, since an output device of the implemented apparatus is an LCD, the reference output result (reference data) includes image data to be displayed on an LCD and position data for displaying on the LCD. It is noted that when an application program AP is under development, a reference output file OF for upgrading the version of the application program AP may be created. In this instance, the reference output file OF can add corrections of bugs or changes in the specification and the like to the automated evaluation items of the application program AP so that the automated evaluation including the changes in the application program AP can be performed. Alternatively, after the user inputs an input event by a key operation, image data for displaying on the LCD may be formed as a reference output result by a reference data creating editor of the automated evaluation system 1.

Finally, the automated evaluation system 1 stores reference data for the entire reference output results in the reference output file OF. It is noted that the reference output file OF is stored in a storage media with an optional filename being added, and is set in the state such that it can be read from the disk apparatus DU. The file name of the reference output file OF is described in the input event file IF, and the reference output file OF is read according to the input event file IF. Therefore, the reference output file OF is modified according to the input event file IF. For example, as shown in FIG. 3 (b), let us assume that, before the input event 20 is inputted, a reference output picture 21 displays [_] on its left upper end on the LCD.

Then, when the keys are operated for the input event 20 as shown in FIG. 3 (a), a reference output picture 22 displays [ABC_] starting from the left upper end to the right on the LCD as a reference output result 23. In this case, the reference output result 23 is stored as reference data including image data for displaying [ABC_] on the LCD and position data for displaying the image on the LCD in the reference output file OF.

Next, referring to FIG. 2, operations of the automated evaluation system 1 and the simulator 2 that take place when an automatic evaluation is performed are described.

The automated evaluation system 1, when started by the user, loads input event data ID stored in the input event file IF from the disk apparatus DU onto the personal computer PC. It is noted that the input event file IF is designated by its file name by the user. When the input event file IF is loaded, the automated evaluation system 1 loads reference data RD stored in the reference output file OF having the filename described in the input event file IF onto the personal computer PC.

Then, the automated evaluation system 1 transfers one input event from the input event data ID to the simulator 2. For transmission of the input event, an API [Application Programming Interface] command of the OS [Operating System] on the personal computer is used. For example, when the OS is Windows, one API command, i.e., FindWindow is used to obtain a window handle of the simulator 2. Then, another API command, PostMessage is used to transmit the one input event among the input event data ID to the window handle. In other words, the automated evaluation system 1 and simulator 2 can transmit input events to each other by using API commands. It is noted that the automatic evaluation system 1 and the simulator 2 use the functions that are provided in the operating system, such as, API commands. Therefore, a special function for transmitting input events does not need be added.

Each time an input event is transmitted, the simulator 2 simulates an operation to be performed by the application program AP based on the input event. Then, the simulator 2 temporarily stores LCD display image data and position data as a simulation result in the RAM 10 for displaying on the display DP. Also, the simulator 2 displays the LCD display image data stored in the RAM 10 on the display DP.

The process performed by the simulator 2 is the same as the normal process in which an operation by the application program AP is simulated, and a special process is not performed for the automated evaluation. Therefore, the application program AP that is the same as an application program actually mounted on a microcomputer can be used. It is noted that the RAM 10 is a built-in RAM in the personal computer PC, and is a RAM that is commonly shared by the automated evaluation system 1 and the simulator 2. Therefore, the RAM 10 can be accessed from the automated system 1 and the simulator 2. In other words, the automated evaluation system 1 and the simulator 2 can communicate with each other with respect to simulation results through the RAM 10. Since the automated evaluation system 1 and the simulator 2 use the RAM 10 of the personal computer PC, no special function needs to be added for referring to the simulation result. It is noted that the RAM 10 may be a VRAM of the personal computer.

It is noted that, in the present embodiment, the RAM 10 corresponds to a storage device.

After the simulation, the automated evaluation system 1 refers to the simulation result stored in the RAM 10. Then, the automated evaluation system 1 compares the simulation result and the reference data that is the reference output result (the LCD display image data and the position data) corresponding to the loaded input event in reference data RD, which is transmitted to the simulator 2. The automated evaluation system 1 makes a determination according to whether or not both of the results occur with each other, to thereby evaluate the operation of the application program with respect to the input event. Furthermore, the automated evaluation system 1 stores the determination result in a result log file. The result log file may store all of the determination results, or may store determination results only when the simulation results differ from the reference output results. It is noted that the automated evaluation system 1 may display the simulation results and reference output results side-by-side on the display DP, so that the user can confirm them. Also, the automated evaluation system 1 may display determination results on the display DP.

Each time an evaluation for one input event is completed, the automated evaluation system 1 repeats the process described above for the next input event stored in the input event data ID to thereby carry out the automated evaluation. When the evaluation of all of the input events in the input event data ID is completed, the automated evaluation system 1 stores the result long file in a storage media such as a hard disk or the like according to the instruction by the user, and completes the automated evaluation.

According to the automated evaluation system 1, the automated evaluation system 1 and the simulator 2 can be accessed to each other through API commands and the RAM 10. Therefore, for transferring input events from the automated evaluation system 1 to the simulator 2, or for referring by the automated evaluation system 1 to simulation results of the simulator 2, special functions do not need to be added to the automated evaluation system 1 or the simulator 2. Furthermore, the application program AP does not need to have a function for automated evaluation implemented therein, and can be the same as an application program that is actually mounted on the microcomputer.

The present invention is not limited to the embodiments described above and many modifications can be made.

For example, API commands and the RAM 10 are used such that the automated evaluate system and the simulation apparatus can be accessed to each other. However, other devices can be used without being limited to the embodiment devices.

Also, the automated evaluation system and the simulator are composed on the same personal computer. However, they can be composed on other electronic processors such as workstations.

Since the automated evaluation system in accordance with the present invention described above is capable of accessing to the simulation apparatus, an automated evaluation can be performed using simulation results for input events of the simulation apparatus. In this instance, the simulation apparatus only performs a normal simulation for the input events. Accordingly, there is no need to implement a function for automated evaluation in the application program. Accordingly, the quality of the application program is equivalent to that of an application program mounted on a target system.

Also, the automated evaluation system in accordance with the present invention is equipped with a storage device that can be accessed by the automated evaluation system and the simulation apparatus, such that the automated evaluation system and the simulation apparatus can be accessed to each other. Therefore, in an automated evaluation by the automated evaluation system and the simulation apparatus, a function for automated evaluation does not need to be implemented. As a result, the stability in the automated evaluation can be maintained.

Scope of claimed invention:

1. an automated evaluation system that automatically evaluates an application program to be operated on a target system according to a given input event and a reference output result corresponding to the given input event, the automated evaluation system characterized in:
being accessible to a simulation apparatus that simulates an operation of the application program; and
comparing a simulation result corresponding to the given input event by the simulation apparatus with the reference output result to thereby perform an automated evaluation.

2. An automated evaluation system according to claim 1, comprising a memory device that is accessible by the simulation apparatus and the automated evaluation system,
wherein the simulation apparatus compares the simulation result stored in the memory device with the reference output result.

3. An automated evaluation system according to claim 1, wherein the simulation apparatus and the automated evaluation system are realized using a common computer.

4. A program that renders a computer to perform an automated evaluation of a application program to be operated on a target system according to a given input event and a reference output result corresponding to the given input event, the program characterized in being
accessible to a simulation apparatus that simulates an operation of the application program, and comparing a simulation result corresponding to the given input event by the simulation apparatus with the reference output result to thereby render the computer to perform an automated evaluation of the application program.

5. A program according to claim 4, wherein access to the simulation apparatus is conducted through an application programming interface implemented in an operating system of the computer.
